(19) United States
(12) Patent Application Publication
(10) Pub. No.: US 2017/0004646 A1
(43) Pub. Date: Jan. 5, 2017

(54) SYSTEM, METHOD AND COMPUTER PROGRAM PRODUCT FOR VIDEO OUTPUT FROM DYNAMIC CONTENT

(71) Applicant: Kelly Phillipps, Murray, UT (US)

(72) Inventor: Kelly Phillipps, Murray, UT (US)

(21) Appl. No.: 15/200,370

(22) Filed: Jul. 1, 2016

Related U.S. Application Data
(60) Provisional application No. 62/188,454, filed on Jul. 2, 2015.

(51) Int. Cl. G06T 13/80; G06T 11/60

(52) U.S. Cl. CPC G06T 13/80; G06T 11/60

(57) ABSTRACT

A system, method, and computer program product are disclosed for combining data and instructions to produce high quality video effects. The resulting video content includes dynamic data that was not seen or anticipated when the effect was created. The effects are controlled via meta-data and rules that alter the effects to enhance the visual representation of the source data to communicate it with metaphors, or as text, that also enhances the conveyance of the data by the attributes of the text including size, movement, color, and an additional plurality of possible attributes. In an embodiment, an electronic message comprising a personalized congratulatory message embedded in a video is created from input received from a plurality of user client computing devices. The video comprises text messages displayed letter-by-letter, the facial image of person being congratulated, animated moving objects and any combination thereof.

### PRIORITY CLAIM

This application claims priority to Provisional U.S. Patent Application Ser. No. 62/188,454 filed Jul. 2, 2015, entitled “Video Output from Dynamic Content”, and which is hereby incorporated by reference in its entirety.

### COPYRIGHT NOTICE

A portion of the disclosure of this provisional patent application document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TRADEMARKS DISCLAIMER

The product names used in this document are for identification purposes only. All trademarks and registered trademarks are the property of their respective owners.

### FIELD OF THE DISCLOSURE

This invention relates to video and more particularly relates to generating video output by an unskilled user from dynamic content.

### BACKGROUND OF THE DISCLOSURE

Producing video effects of complex data sources, such as a full motion data visualization of time series data as a moving info-graphic, or users input converted to populate a video greeting card, requires an expert using of video production tools. For simple things like titles or simple transitions, an end user may use a consumer based tool as opposed to a professional video effects software solution. But for something as complex as rendering time series data into a dynamic full motion video effect, the user must rely upon professional tools.

The current state of the art requires the construction of multiple static elements, which are then sequenced together to simulate a mass customization of the video content. An example of this would be recording hundreds of people's names which are then spliced into where an individual's name would occur, such as on an electronic greeting card. Another example of the prior art allows an image of a person's face to be merged into a pre-recorded scene and manipulated to appear to speak through manipulation of the mouth (such as JibJab®). Other than these examples of automated video content manipulation for personalization, the current state of the technology is designed to require a professional video artist to control the video effects using complex tools to alter the appearance of the effects. The resulting complexity of the technologies and the required expertise restrict a normal person without the required skill set from composing a video with complex content. For example, video templates (e.g. VideoHive™) are commercially available for inputting dynamic and static content to generate a video with time lapse movement, but they require editing by a video professional, versus an unskilled user.

Additionally, and in one particular embodiment comprising video greeting cards used by companies for employee recognition, they require that each card be authored in a target language. The current technologies are not dynamic to support a multitude of different written languages. As a result, each supported language requires a unique static video content to be generated.

Therefore, there is a need in the video production industry for a user friendly tool comprising video templates to enable the user to create an animated video comprising moving and/or time lapse displays of pictures, text, symbols, etc. without requiring the user to have advance video editing skills, and while also allowing the user to create the video in a user selected language.

### SUMMARY OF THE DISCLOSURE

Apparatuses, systems, methods, and computer program products are disclosed for video output from dynamic content. In certain embodiments, an apparatus, system, and/or computer program product may be configured to perform or may include instructions to perform one or more of the method steps described herein. The various embodiments of the present disclosure comprise a significant improvement over the prior art in that rules are constructed to translate non-video specific end user inputs and data elements into the control of a video effect. The rules control literal and metaphorical visual elements that allows the user to visualize their inputs and the data represented as a video without any interactions with video editing technology.

Furthermore, the various embodiments of the present disclosure allow the user to construct videos using dynamic content which is managed at the character level based on fonts that have a number of language variations. By allowing the user to select their desired language to input their data, the content is by nature language enabled.

Various embodiments of a method include generating full motion typographical content and charts for data analytics visualizations from a data integration to a relational database.

Another embodiment of a method includes altering the attributes of a metaphorical element based on the variable data combined with the meta-data. An example of this, in one embodiment, includes presenting a comparison of the sales of trucks verses cars as an image of a truck growing larger as an image of a car grows smaller.

Another embodiment of a method includes accepting user input and combining the user input with other external data from a plurality of sources.

Another embodiment of a method includes processing variables associated with digital assets, such as “special effects”, which may be merged with predefined video assets based on rules and meta-data that may be controlled by variable data to produce a video greeting card. One example of a rule which interacts with the meta-data to produce an effect is changing the size of a fireworks effect based on exceeding a sales goal where the meta- data determines how much to increase or decrease the number and speed of particles being emitted to convey through the metaphor exceeding the sales goal. In this example an association between a sales goal and the controls of a particle generator is not a natural relationship, yet with the meta-data layer and rules engine, a translation can be made to convey the information through the visual metaphor.

Other embodiments of a method include allowing a user to select from a plurality of templates, which may be merged with variable data from one or more sources. Templates may include holidays, recognition events for a job well done, or working long hours to deliver a critical project.

Various embodiments of a method include rendering full motion video from a native data source of time series data, which may be animated with video special effects and presented as full motion analytical data visualizations. Time series data that has changing ratios over time is represented with motion, because without motion the data would require a series of static charts for each time period. Viewing time series data that alters its rate of change has a greater impact on the viewer when it is in full motion, as compared to a series of static charts.

An exemplary embodiment of the present disclosure comprises animating a physical award, such as an oversized metal version of a company logo that is etched with the employee's name. It can also be rendered as an animated computer generated image of the physical award. The generated images include a video effect that merges etched lettering onto the virtual award with the same employee's name that is on the physical award.

Various embodiments of a method include displaying an output from a website comprising the video and/or sending the output as an email to a recipient and/or list of recipients.

Various embodiments of a method include generating a plurality of unique videos each with unique content that is specific to a target audience. One example of this, in certain embodiments, includes a list of recipients that have been identified in a mass distribution of video cards, which may have one or more variable elements which may be included in customized content.

Various embodiments of a method include processing data against rules to determine a plurality of attributes of a video animation such as speed, color, transparency, size, or the like.

Various embodiments of a method include generating a video greeting card which acknowledges an employee of a company for years of service and/or another performance related accomplishment such as good results on a project, maintaining a healthy lifestyle, or the like.

Various embodiments of a method include generating announcements that may be broadcast to a group which may be customized by a sender.

Various embodiments of a method include determining video output based on employee data, such as a work anniversary date.

One or more embodiments of the present disclosure comprises a computer method, and a non-transitory computer readable storage medium having embodied thereon a program executable by a processor to perform a method for generating an animated video, the method comprising: transmitting an electronic message to one or more client computing devices comprising an invitation for a user to input at least one textual message and/or at least one visual effect to create an animated video; receiving the user input by a computer system comprising a dynamic video module, at least one non-video external data, and at least one video template that generates video metadata; and merging the user input and/or the non-video external data with the video metadata to render a video visualization output based on one or more rendering rules.

One or more embodiments further comprises a computer system able to generate video output from dynamic content input, comprising: a dynamic video module in communication with one or more client computing devices over a data network; one or more client computing devices able to receive user input and display a video output; a data network comprising internet transmissions; one or more non-video external data; at least one video template that generates video metadata; and wherein the dynamic video module is able to merge the user input and/or the non-video external data with the video metadata to render a video visualization output based on one or more rendering rules.

One or more embodiments further comprises: an apparatus for creating and displaying a user customized video, the apparatus comprising: a memory; a processor executing instructions stored in the memory; a network communication interface; and a display, the apparatus configured to: display an electronic message comprising an invitation for an apparatus user to input at least one textual message and/or at least one visual effect to create a customized animated video; receive a user input comprising selection of a language, a textual message, an animated moving object, a video template, or any combination thereof; transmit the user input via a network to a remote server, wherein the server merges the user input and/or at least one non-video external data with the video metadata generated from the video template to render a video visualization output based on one or more rendering rules. The apparatus then receives via the network, and displays the video visualization output on the apparatus display. By way non-limiting examples, the apparatus is a smartphone, tablet, PDA, laptop or desktop; and the video visualization output comprises an animated greeting card, or an animated employee recognition card, signed by the users of one or more apparatuses, and displaying the name and facial image of a person being recognized.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 depicts one embodiment of a system for video output from dynamic content;

FIG. 2 depicts one embodiment of components of a dynamic data driven video illustration generation system;

FIG. 3 depicts one embodiment of a system for mass generation and distribution of video output from dynamic content;

FIG. 4 depicts one embodiment of a system for groups of authors to be invited to contribute to a resulting video greeting card comprising video output from dynamic content;

FIG. 5A illustrates an exemplary embodiment of a screen shot from an employee recognition video comprising a race car being drawn and spinning around; and

FIG. 5B illustrates the exemplary embodiment of FIG. 5A a few seconds later after the race car has driven off and is replaced with the text in the middle of the image.

### DETAILED DESCRIPTION OF AN EXEMPLARY EMBODIMENT

### Glossary of Terms

As used herein, the term “Client Device” refers to any user electronic computing device comprising a central processing unit (i.e. processor) with the ability to transmit and receive electronic communications comprising via Internet and/or cellular connectivity, such as a laptop or desktop computer, a tablet, a smartphone, a personal digital assistance (PDA) device, etc. In particular embodiments disclosed herein, a user client device receives a user's input for creating a video, and displays the animated video.

As used herein, the term “Network” refers to any public network such as the Internet or World Wide Web, or any public or private network as may be developed in the future, which provides a similar service as the present Internet. The user client device transmits user input via the network.

As used herein, the term “Software” or “Computer Program Product” refers to computer program instructions adapted for execution by a hardware element, such as a processor, wherein the instruction comprises commands that when executed cause the processor to perform a corresponding set of commands. The software may be written or coded using a programming language and stored using any type of non-transitory computer-readable media or machine-readable media well known in the art. Examples of software in the present invention comprise any software components, code, modules, programs, applications, computer programs, application programs, system programs, machine programs, and operating system software. The software, or computer program product is installed within memory on a user client device, or is cloud based, or otherwise stored in memory of a remote computing system accessible via the client device through the network.

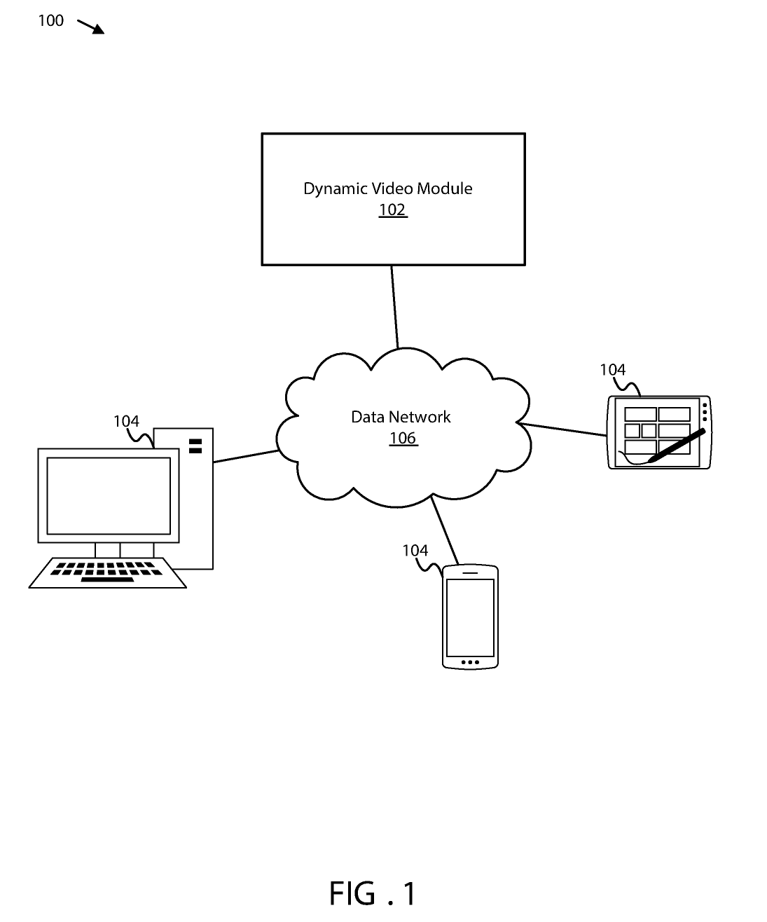

As used herein, the term “Computer System”, “Computerized System” or “Multi-device Computerized System” may be used to claim all aspects of the present disclosure wherein it refers to the entire configuration of hardware and software in all embodiments, such as shown in FIG. 1. In one embodiment, the “computer system” comprises at a minimum: the system server, with a network connection, a memory, at least one processor (CPU), and which may further comprise a database of records. In another embodiment, the computer system comprises a client-server architecture with at least one user client computing device with Internet connectivity to communicate with a remotely located, or cloud based, system server via a network, wherein the software of the present disclosure is installed on the system server and electronically communicates with the user's client device over the network (e.g. the Internet).

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “circuit,” “module,” “apparatus,” or “system.” Furthermore, aspects of the present disclosure may take the form of a computer program product embodied in one or more non-transitory computer readable storage media storing computer readable and/or executable program code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented at least partially in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may include a single instruction, or many instructions, and may even be distributed over several different code segments, among different programs, across several memory devices, or the like. Where a module or portions of a module are implemented in software, the software portions may be stored on one or more computer readable and/or executable storage media. Any combination of one or more computer readable storage media may be utilized. A computer readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the modules described herein, in certain embodiments, may alternatively be embodied by or implemented as a component.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

FIG. 1 depicts one embodiment of a computer system 100 for video visualization output from dynamic content. The system 100, in the depicted embodiment, includes a dynamic video module 102 in communication with one or more client computing devices 104 over a data network 106. The dynamic video module 102, in one embodiment, determines or produces one or more video assets, which the dynamic video module 102 may instrument to receive and/or include variable content, wherein the content and/or the video may be adapted to allow for variations in the content based on a rule set or the like.

The dynamic video module 102 may adapt the content and/or the video to match one or more attributes such as format, style, and/or dimensions of predefined effects, which the dynamic video module 102 may control using instrumentation incorporated within the video, or the like.

The dynamic video module 102 may include instrumentation within a video which may generate video special effects for time series data that may be animated to enhance data visualization, or the like. The dynamic video module 102 may generally target effects at enhancing the meaning of the visualized data, such as highlighting a rate of change over time of a data element, comparing rates of change of multiple data elements, or the like.

The video effects created and/or provided by the dynamic video module 102, such as charts, graphs, or the like, may be adapted to the data by the dynamic video module 102 with little or no manual intervention or alteration of the source data based on the rules, which may be managed by input meta-data resulting in the data, combined with the rules, controlling the effects or the like.

The dynamic video module 102 may acquire data driven analytical charts, graphs, and/or data that drives video card content from a native data source such as a relational database or the like.

The dynamic video module 102, in certain embodiments, may include a rules engine that may generate instructions or other output metadata to control variables in the effects that will be applied to the data, or the like.

The dynamic video module 102 may generate video greeting cards from a number of templates that may be driven by instructions that are built for each template, or the like.

The dynamic video module 102 may compose full motion video data visualizations iteratively from a single template but against different data sets, or the like, by constructing an individual visualization and iterating through a list of data sets. The dynamic video module 102 may use this feature to generate many similar visualizations with a common format, such as for a company that would like to distribute the same visualizations across many departments, based on different data.

In one embodiment, the dynamic video module 102 may combine a single template with a plurality of unique data sets to generate a video for each output. For example, the dynamic video module 102 may distribute a similar but individualized video to a large group of people in an organization for a holiday greeting or as acknowledgement sent to a team for a job well done, each using a similar template but based on different input data.

In one embodiment, the dynamic video module 102 broadcasts an invitation to multiple people with a link to a capture point where the people may each contribute to the same video greeting card. The dynamic video module 102 may combine the different input from the different people together into a single card.

In one embodiment, the dynamic video module 102 broadcasts an invitation to multiple people to contribute to a group card which the dynamic video module 102 may combine with other information, such as a work anniversary date which the dynamic video module 102 may acquire from an integration to a corporate data source such as a human resources system or the like.

In one embodiment, the dynamic video module 102 broadcasts an invitation to multiple people with a link to a capture point where the people may each select a different video greeting card to be composed and delivered in an orchestrated way as a group of cards combined together around a central event.

In one embodiment, the dynamic video module 102 broadcasts an invitation to multiple people with a link to a capture point where the people may each select a section of a mosaic of video greeting cards that are standalone but also combine together into a themed mosaic with each card contributing an element to the visual and narrative content.

In one embodiment, the dynamic video module 102 may produce a video greeting card to commemorate a work related event, such as an anniversary date for an employee, or the like.

In one embodiment, the dynamic video module 102 may produce a data visualization based on a rule set that controls the effects of the data visualization, such as the animation of charts and graphs that represent time series data with effects that are designed to better communicate the relations of data as it changes over time, or the like.

The dynamic video module 102 may distribute a final product various ways, including via email, retrieved from a link to a website, incorporated into a web page such as an employee recognition website or company employee portal, or the like.

In one embodiment, the dynamic video module 102 may offer a plurality of written languages such as French, English, Spanish, or the like for data integration and/or user input, which the dynamic video module 102 may render into video output in their native form, or the like.

In one embodiment, the dynamic video module 102 may combine multiple languages into one multi-lingual output, or the like.

In one embodiment, the dynamic video module 102 may process time series data using a plurality of rules to render representations of the data through the attributes and movements of animated objects, or the like.

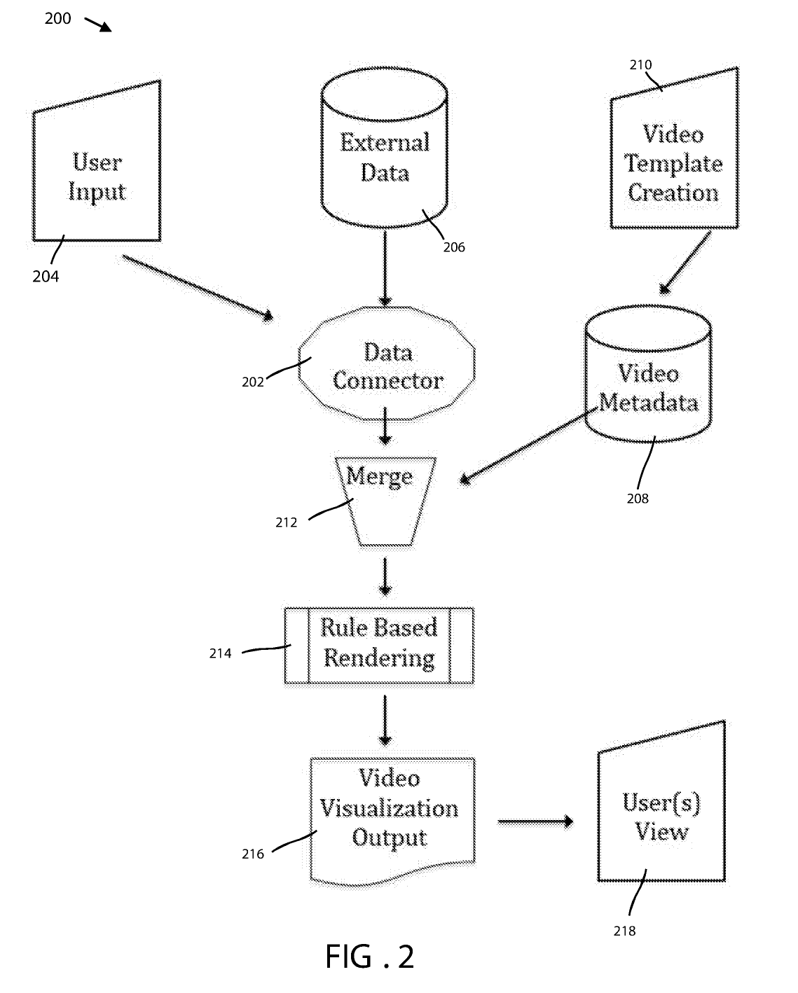

FIG. 2 depicts one embodiment of components 200 of a dynamic data driven video illustration generation system, such as the dynamic video module 102 described above. In the depicted embodiment, the dynamic video module 102 may receive user input 204 and/or external data 206, using a data connector 202 or the like. The dynamic video module 102 may merge 212 the user input 204 and/or external data 206 with video metadata 208, from one or more video templates 210 or the like, and render them into video visualization output based on one or more rendering rules 214. The dynamic video module 102 may provide the output video 216 to one or more users 218 for viewing on their client computing devices 104, using a web page, in an email, or the like.

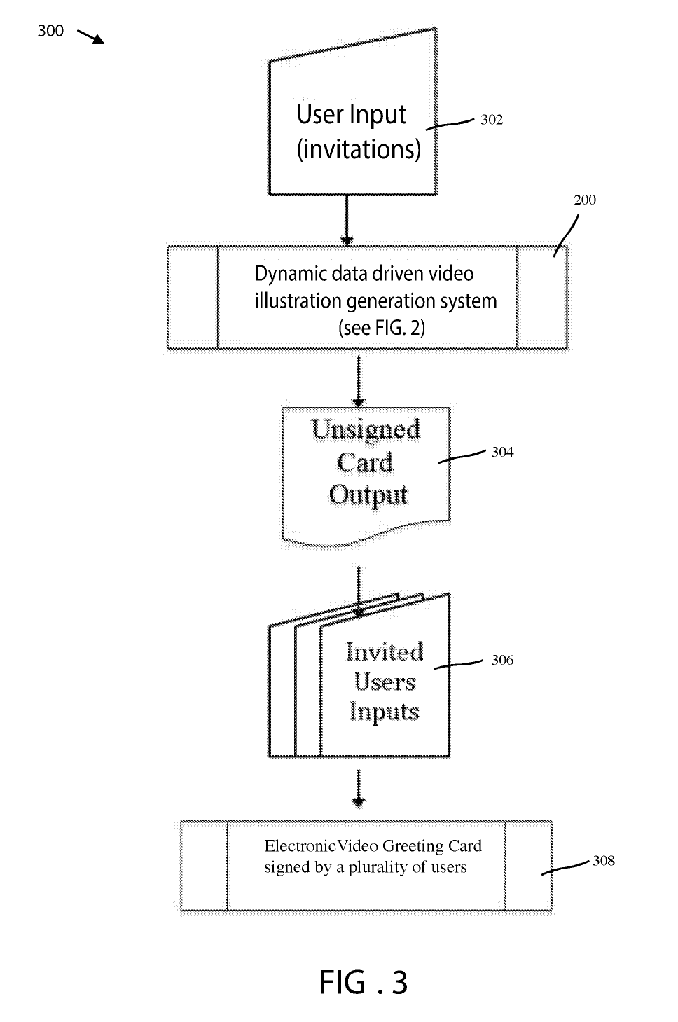

FIG. 3 depicts one exemplary embodiment of the implementation of dynamic data driven video illustration generation system (FIG. 2, 200). The exemplary embodiment comprises a system 300 for the mass generation and distribution of video output from dynamic content, by the dynamic video module 102 or the like, for the purpose of enabling a plurality of users to sign a greeting card from using their own client device (e.g. FIG. 1, 104). In the depicted embodiment, the dynamic video module 102 may send invitations 302 to a plurality of users to collaborate on an electronic video greeting card, and may receive user input 306 from one or more of the users in response to sending the invitations. The dynamic video module 102 may combine the user input 306 from the one or more users with unsigned card output 304 (e.g., a video card template or the like) to output an electronic video greeting card 308 based on the input from multiple users.

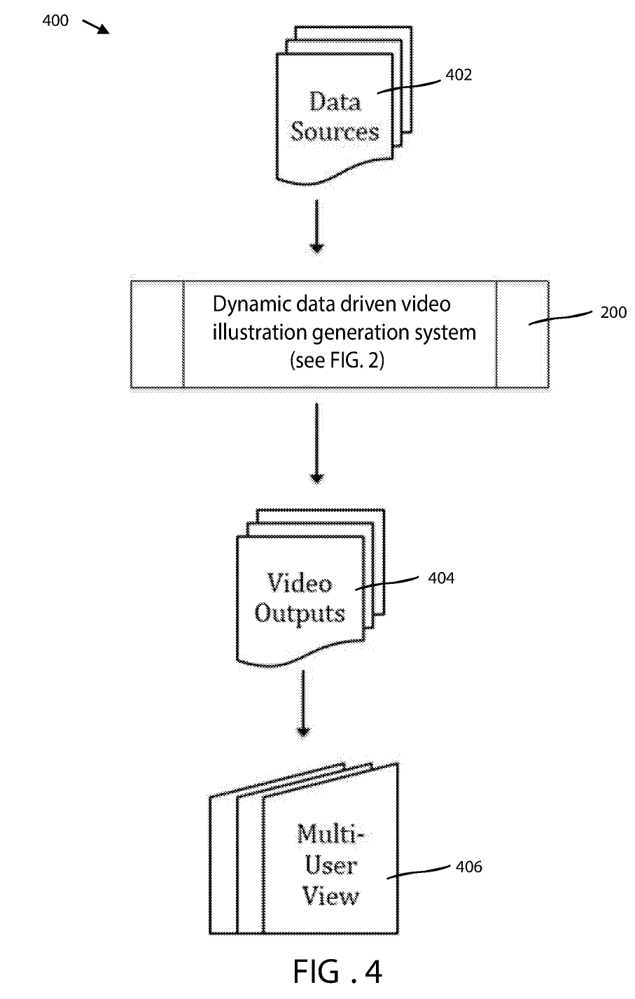

FIG. 4 depicts another exemplary embodiment of a system 400 for groups of authors to be invited to contribute to a resulting video greeting card comprising video output from dynamic content. For example, in the depicted embodiment, the dynamic video module 102 may combine data from multiple data sources 402, such as a corporate database, user input into a website form, or the like, to create video outputs 404 for multiple users to view 406, as described above.

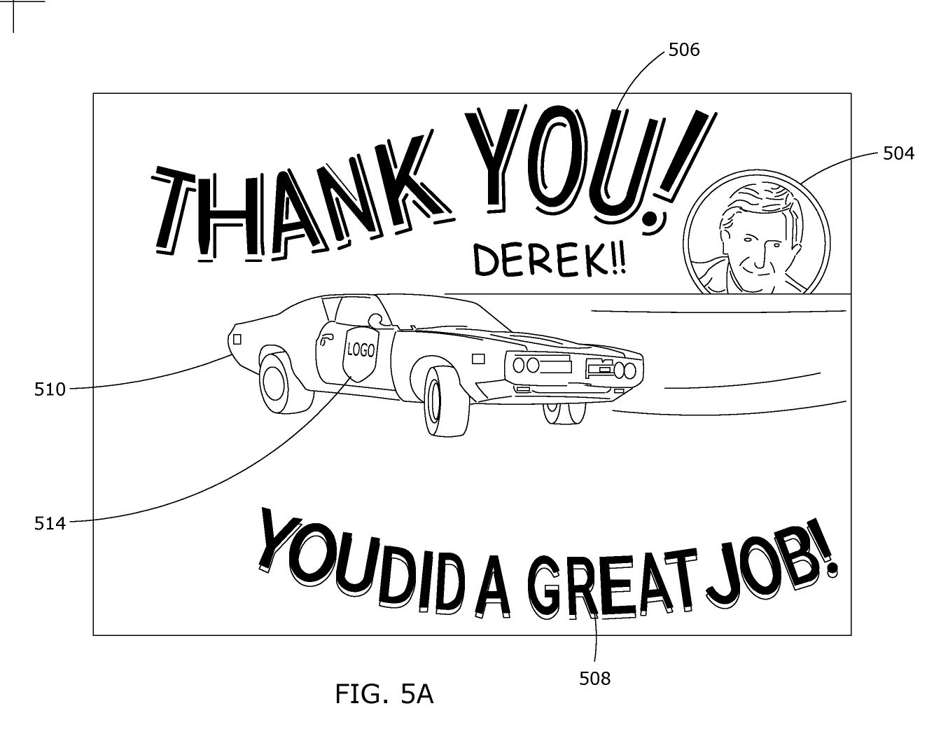

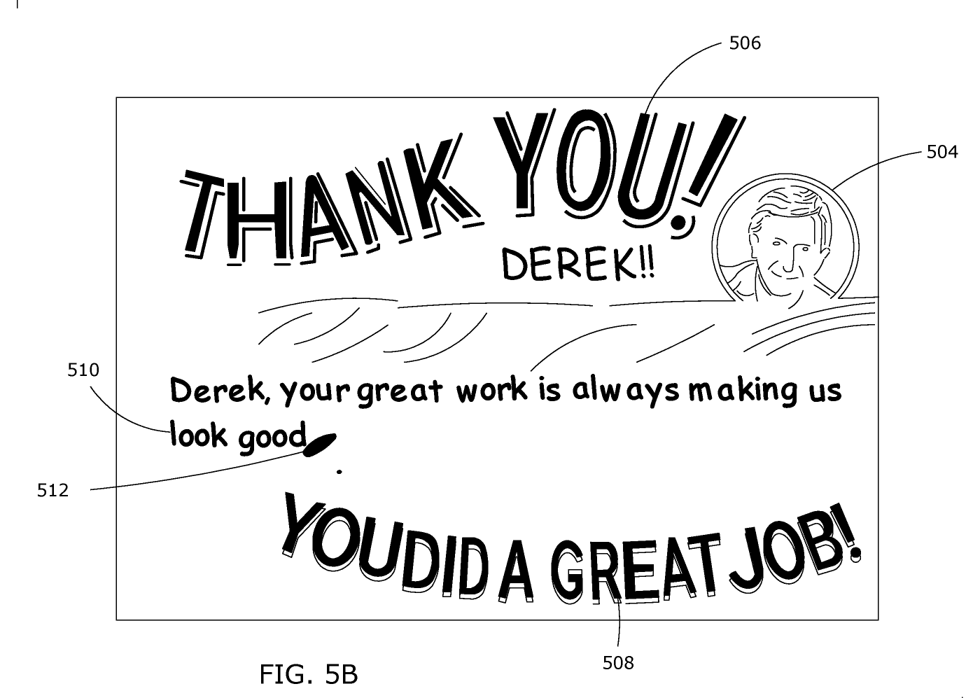

FIGS. 5A and 5B illustrate an exemplary embodiment of screen shots from an employee recognition video. In the time sequence of the video, an image of a race car 502 is drawn with a chalk 512, and then the car spins around 360 degrees and finally races off the screen at the far right lower corner. Currently, a facial image of the employee 504, and their name with a “Thank You!” note 506 is printed letter-by-letter, as if the letters are being typed in. Then the statement “You Did a Great Job!” 505 is printed letter-by-letter below the race car. And as the race car exits the screen, its image is replaced with the statement “Derek, your great work is always making us look good” 510 is written with chalk 512.

The data input of FIGS. 5A and 5B can be categorized or described as follows: the race car 502 is a video animation asset; the facial image 504 is a user submitted image asset; a custom image asset is the UPS® logo 514 on the race car door; text 506 and 508 are examples of user submitted content as typographical effect; and chalk 512 is an example of motion animation based on user content.

The various embodiments of the present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system able to generate a video visualization output from dynamic content input, comprising,
a dynamic video module in communication with one or more client computing devices over a data network;
one or more client computing devices able to receive a user input and display a video visualization output;
a data network comprising internet transmissions;
one or more non-video external data;
at least one video template that generates a video metadata;
wherein the dynamic video module is able to merge the user input and/or the non-video external data with the video metadata to render a video visualization output based on one or more rendering rules; and
wherein the user selects which language from a plurality of languages to input and display the output.

2. The computer system of claim 1, wherein the video visualization output is displayed on the client computing device as a webpage, within an email, or within an email comprising a link to a webpage.

3. The computer system of claim 1, wherein the video visualization output comprises one or more video effects that are translated into one or more visual metaphors based on the rendering rules.

4. The computer system of claim 3, wherein the visual metaphor is a virtual representation of a physical award given to a person being congratulated.

5. The computer system of claim 1, wherein the video effects comprise one or more of: a text message typed in letter-by-letter, a facial image and name of a person being congratulated, and an animated moving object.

6. The computer system of claim 5, wherein the animated moving objects comprise one of: a fire, a snow, a smoke, a fireworks display, a water, a writing chalk, a spool of thread, and a moving vehicle, or any combination thereof.

7. The computer system of claim 1, wherein the dynamic video module is able to transmit an electronic message comprising an invitation to create an animated video, and to receive input from the one or more client computing devices.

8. The computer system of claim 7, wherein the electronic message comprising the invitation is able to be forwarded from one recipient client computing device to one or more client computing devices with a request to input a congratulatory message and/or a signature.

9. The computer system of claim 1, wherein the dynamic video module is able to process a data against the rendering rules to determine one or more attributes of the video, comprising speed, color, transparency, movement, and size.

10. The computer system of claim 1, wherein the video visualization output comprises an animated greeting card, or an employee recognition card, signed by the users of one or more client computing devices, and displaying the name and facial image of a person being recognized.

11. A computer method of generating an animated video authored by at least one user of a client computing device, comprising:
transmitting by a computer system an electronic message to a one or more client computing devices comprising an invitation for a user to input at least one textual message and/or at least one visual effect to create an animated video;
receiving the user input by the computer system, wherein the computer system comprises a dynamic video module, at least one non-video external data, and at least one video template that generates video metadata;
merging by the computer system the user input and/or the non-video external data with the video metadata to render a video visualization output based on one or more rendering rules; and
transmitting by the computer system an electronic message to the one or more client computing devices comprising the video visualization output.

12. The computer method of claim 11, wherein the video visualization output is displayed on the client computing device as a webpage, an email, or an email comprising a link to a webpage.

13. The computer method of claim 11, wherein the video visualization output comprises one or more user selected video effects that are translated into visual metaphors based on the rendering rules.

14. The computer method of claim 13, wherein the user selected video effects comprise one or more of: a text message typed in letter-by-letter, a facial image and a name of a person being congratulated, and at least one animated moving object.

15. The computer method of claim 14, wherein the animated moving objects comprise one of: a fire, a snow, a smoke, a firework, a water, a writing chalk, a spool of thread, and a moving vehicle, or any combination thereof.

16. The computer method of claim 11, wherein the electronic message comprising the invitation is forwarded from a recipient client computing device to one or more client computing devices with a request to input a congratulatory message and/or a signature.

17. The computer method of claim 11, wherein the video visualization output comprises an animated greeting card, or an animated employee recognition card, signed by the users of the one or more client computing devices, and displaying the name and facial image of a person being recognized.

18. The computer method of claim 11, wherein the user input is in a user selected language.

19. A non-transitory machine-readable storage medium having stored thereon a set of instructions which when executed causes a computing system to perform a method comprising,
transmitting by a computer system an electronic message to one or more client computing devices comprising an invitation for a user to input at least one textual message and/or at least one visual effect to create an animated video;
receiving the user input by the computer system, wherein the computer system comprises a dynamic video module, at least one non-video external data, and at least one video template that generates video metadata;
merging by the computer system the user input and/or the non-video external data with the video metadata to render a video visualization output based on one or more rendering rules, wherein the dynamic video module is able to process a data against the rendering rules to determine one or more attributes of the video, comprising speed, color, transparency and size; and
transmitting by the computer system an electronic message to one or more client computing devices comprising the video visualization output.

20. A non-transitory machine-readable storage medium 19, wherein the video visualization output comprises one or more user selected video effects that are translated into visual metaphors based on the rendering rules.

21. A non-transitory machine-readable storage medium 20, wherein the user selected video effects comprise one or more of: a text message typed in letter-by-letter, a facial image and a name of a person being congratulated, and at least one animated moving object.
